(19) United States
(12) Patent Application Publication
(10) Pub. No.: US 2019/0145314 A1
(43) Pub. Date: May 16, 2019

(54) HIGH PRESSURE COMPRESSOR DIFFUSER FOR AN INDUSTRIAL GAS TURBINE ENGINE

(71) Applicant: Florida Turbine Technologies, Inc., Jupiter, FL (US)

(72) Inventors: John A OROSA, Palm Beach Gardens, FL (US); Joseph D BROSTMEYER, Jupiter, FL (US); Russell B JONES, North Palm Beach, FL (US); Justin T CEJKA, Palm Beach Gardens, FL (US)

(21) Appl. No.: 16/094,378

(22) PCT Filed: Apr. 24, 2017
(86) PCT No.: PCT/US2017/029152

§ 371 Date: Oct. 17, 2018

Related U.S. Application Data
(63) Continuation of application No. 15/444,374, filed on Feb. 28, 2017.
Application No. 15/444,374 is a continuation of application No. 15/137,280, filed on Apr. 25, 2016.

(51) Int. Cl. F02C 6/08; F02C 7/18; F02C 9/18; F04D 29/54; F04D 29/68; F02C 3/04; F04D 19/02

(52) U.S. Cl. CPC F02C 6/08; F02C 7/18; F02C 9/18; F04D 29/541; F04D 29/682; F05D 2220/32; F04D 29/545; F04D 19/02; F05D 2220/76; F05D 2260/232; F02C 3/04

(57) ABSTRACT

An industrial gas turbine engine with a high spool and a low spool in which low pressure compressed air is supplied to the high pressure compressor, and where a portion of the low pressure compressed air is bled off for use as cooling air for hot parts in the high pressure turbine of the engine. Annular bleed off channels are located in the LPC diffuser. The bleed channels bleed off around 15% of the core flow and pass the bleed off air into a cooling flow channel that then flows into the cooling circuits in the turbine hot parts.

### GOVERNMENT LICENSE RIGHTS

This invention was made with Government support under contract number DE-FE0023975 awarded by the United States Department of Energy. The United States Government has certain rights in the invention.

### TECHNICAL FIELD

The present invention relates generally to an industrial gas turbine engine for electric power generation, and more specifically to a twin spool industrial gas turbine (IGT) engine for electrical power production having a diffuser, in which some of the core flow from the compressor discharge is drawn off and used to cool hot parts of the turbine and/or to improve the performance of the diffuser.

### BACKGROUND

An industrial gas turbine engine is used for electrical power production where the engine drives an electric generator. Compressed air from a compressor is burned with a fuel in a combustor to produce a hot gas stream that is passed through a turbine, where the turbine drives the compressor and the electric generator through the rotor shaft. In an industrial gas turbine for electric power production, the speed of the generator is the same as the rotor of the engine since the use of a speed reduction gear box decreases the efficiency of the engine. For a 60 Hertz system, the generator and engine speed is 3,600 rpm. For a 50 Hertz system like that used in Europe, the generator and the engine speed is 3,000 rpm.

Engine efficiency can be increased by passing a higher temperature hot gas stream through the turbine. However, the turbine inlet temperature is limited to material properties of the turbine parts exposed to the hot gas stream such as rotor blades and stator vanes especially in the first stage. For this reason, first stage airfoils are cooled using cooling air bled off from the compressor. Cooling air for the airfoils passes through elaborate cooling circuits within the airfoils, and is typically discharged out film cooling holes on surfaces where the highest gas stream temperature are found. This reduces the efficiency of the engine since the work done by the compressor on compressing the cooling air is lost when the spent cooling air is discharged directly into the turbine hot gas stream because no additional work is done on the turbine.

### SUMMARY

An industrial gas turbine engine for electrical power production, where the engine includes a high spool that drives an electric generator and a separate low spool that produces compressed air that is delivered to an inlet of the high pressure compressor (HPC) for turbocharging the high spool. A portion of the low pressure compressor (LPC) outflow or core flow is bled off and used as the cooling air for hot parts of the high pressure turbine (HPT). The cooling air flows through the hot parts for cooling, and is then discharged into the combustor and burned with fuel to produce the hot gas stream for the turbine. The work done on the compressed cooling air is thus not lost but used to produce work in the turbine.

In another embodiment of the present invention, some of the core flow from the diffuser is drawn off using a fan driven by the rotor of the engine to improve the performance of the diffuser. The drawn off core flow is then merged back into the core flow.

In another embodiment of the present invention similar to the second embodiment above, the fan is driven by a motor external to the main duct and the engine.

In one embodiment, an industrial gas turbine engine for electrical power production includes: a high spool with a high pressure compressor and a high pressure turbine; a low spool with a low pressure compressor (LPC) and a low pressure turbine; a core flow duct connecting a core flow of the LPC to an inlet of the high pressure compressor; a LPC diffuser air bleed channel to bleed off a portion of the core flow; and a cooling air duct connected to the LPC diffuser air bleed channel.

In one aspect of the embodiment, the industrial gas turbine engine further includes a LPC diffuser between the LPC and the core flow duct, the LPC diffuser air bleed channel being located on an inner surface of the LPC diffuser, the LPC diffuser air bleed channel bleeding off around 7.5% of the core flow of the LPC.

In one aspect of the embodiment, the LPC diffuser air bleed channel is a first LPC diffuser air bleed channel, and the industrial gas turbine engine further includes a second LPC diffuser air bleed channel located downstream from the first LPC diffuser air bleed channel to bleed off a second portion of the core flow, the second LPC diffuser air bleed channel being connected to the cooling air duct.

In one aspect of the embodiment, the first and second LPC diffuser air bleed channels bleed off around 15% of the core flow of the LPC diffuser.

In one aspect of the embodiment, the industrial gas turbine engine further includes a fan located downstream of the first and second LPC diffuser air bleed channels, the fan being configured to draw off the bleed air through the first and second LPC diffuser air bleed channels to improve the efficiency of the diffuser.

In one aspect of the embodiment, the low spool includes a rotor, the fan being rotatably connected to the rotor.

In one aspect of the embodiment, the industrial gas turbine engine further includes a motor that is external to the low spool, the fan being driven by the motor.

In one aspect of the embodiment, the LPC diffuser air bleed channel has an annular cross-sectional shape.

In one aspect of the embodiment, each of the first and second LPC diffuser air bleed channels has an annular cross-sectional shape, and compressed air from the first LPC diffuser bleed channel flows into the second LPC diffuser bleed channel.

In one aspect of the embodiment, the industrial gas turbine engine further includes a LPC diffuser between the LPC and the core flow duct, the LPC diffuser air bleed channel being located on an inner surface of the LPC diffuser, the LPC diffuser air bleed channel having an annular shaped channel on an inner surface of the LPC diffuser that forms the core flow of the LPC.

In one aspect of the embodiment, the industrial gas turbine engine further includes a LPC diffuser between the LPC and the core flow duct, the LPC diffuser air bleed channel being located on an inner surface of the LPC diffuser, wherein: the LPC diffuser air bleed channel is an annular shaped channel; and the LPC diffuser includes a throat followed by a diverging section is located between the annular bleed channel and the cooling air duct.

In one aspect of the embodiment, the industrial gas turbine engine further includes: a third LPC diffuser air bleed channel located on an outer surface of the LPC diffuser to bleed off a third portion of the core flow; and a third low pressure compressed air bleed channel connected to the cooling air duct.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a cross-sectional view of a twin spool industrial gas turbine engine with a closed loop turbine airfoil cooling circuit of the present invention;

FIG. 2 shows a low pressure compressor of an industrial gas turbine engine with a diffuser in which some of the core flow drawn off and used as cooling air for hot parts of the turbine according to the present invention;

FIG. 3 shows a cross-sectional view of a low pressure compressor of an industrial gas turbine engine with a diffuser in which some of the core flow is drown off from the diffuser by a fan driven by the engine rotor to improve the diffuser performance according to the present invention;

FIG. 4 shows a cross-sectional view of a low pressure compressor of an industrial gas turbine engine with a diffuser in which some of the core flow is drawn off from the diffuser by a fan driven by a motor external to the engine to improve the diffuser performance according to the present invention.

### DETAILED DESCRIPTION

The present invention is a twin spool industrial gas turbine (IGT) engine for electrical power production with a low spool having a low pressure compressor (LPC) and a diffuser, where some of the core flow from the compressor discharge is drawn off and used as cooling air for turbine hot parts and/or where some of the core flow is drawn off by a fan in order to improve the performance of the diffuser. The cooling air is passed through turbine hot parts (such as stator vanes, rotor blades, rotor disks, combustor liners) to be cooled, and then reintroduced into the compressed air from the high pressure compressor upstream of the combustor. The cooling air bled off from the LPC passes through a boost compressor to increase its pressure prior to passing through the hot parts to be cooled so that enough pressure remains after cooling of the hot parts to be discharged into the combustor along with compressed air from the main compressor. The core flow drawn off by the fan to improve the diffuser performance is reintroduced into the core flow duct upstream of the inlet to the high pressure compressor. Cooling air for the turbine hot parts can then be extracted from the core flow duct between the merge section and the inlet to the high pressure compressor.

The outlet of the low pressure compressor (LPC) includes a diffuser with bleed off channels that bleed off a portion of the core flow from the LPC using a fan to draw off the compressed air through the bleed off channels that functions to increase the efficiency of the diffuser. The bleed off compressed air is then reintroduced into the core flow that flows to an inlet of a high pressure compressor (HPC) where some of the core flow is bled off and used for cooling of the high pressure turbine (HPT) hot parts such as stator vanes or rotor blades.

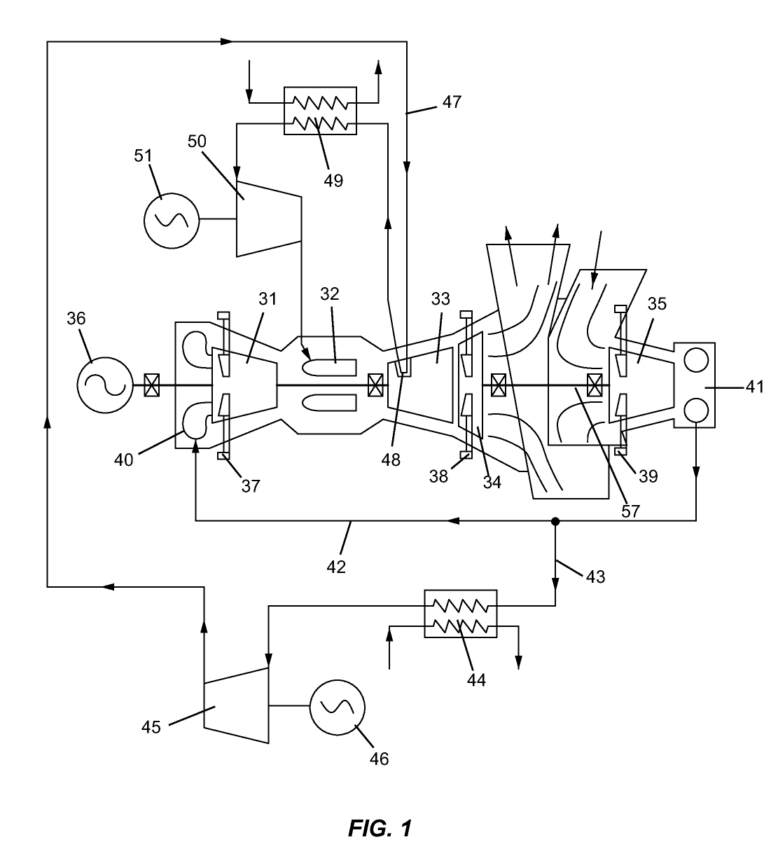

FIG. 1 shows a twin spool industrial gas turbine engine of the present invention for electrical power production. The IGT engine includes a high spool with a HPC 31, a combustor 32 and a HPT 33 that directly drives an electric generator 36. The IGT engine also includes a low spool which functions as a turbocharger for the high spool and includes a LPT 34 that drives a LPC 35 using the exhaust gas from the HPT 33. The LPC 35 compresses air and discharges the compressed air out of an outlet manifold 41 of the low spool and into a main flow or core flow duct 42 that delivers low pressure air to an inlet manifold 40 of the HPC 31 of the high spool. The HPC 31 and the LPC 35 and the HPT 33 each include a variable inlet guide vane assembly (37, 39, 38) that regulates flow into each of these parts of the engine. These variable inlet guide vane assemblies 37, 38, 39 may allow for the engine to produce twice the power of currently known engines, and may allow the high pressure spool and the low pressure spool to be operated independently so that a turn town ratio of as little as 12% can be achieved while still maintaining high engine efficiency.

The core flow from the LPC 35 to the HPC 31 through the core flow duct 42 has a cooling air duct 43 that removes some of the core flow to be used as cooling air for a hot part of the HPT 33, such as a first stage stator vanes or rotor blades 48, in a closed loop circuit 47 in which the spent cooling air from cooling the turbine parts is then discharged into the combustor 32 of the high spool. The cooling air must be increased in pressure to pass through the cooling circuit of the turbine parts and still have enough pressure to flow into the combustor 32. An intercooler 44 cools the compressed cooling air in the cooling air duct 43 and a boost compressor 45 driven by a motor 46 increases the pressure of the cooling air. A second intercooler 49 and a second boost compressor 50 driven by a second motor 51 can be used to increase the pressure of the spent cooling air from the turbine parts 48 prior to discharge into the combustor 32. This discharged air is merged with the compressed air from the HPC 31.

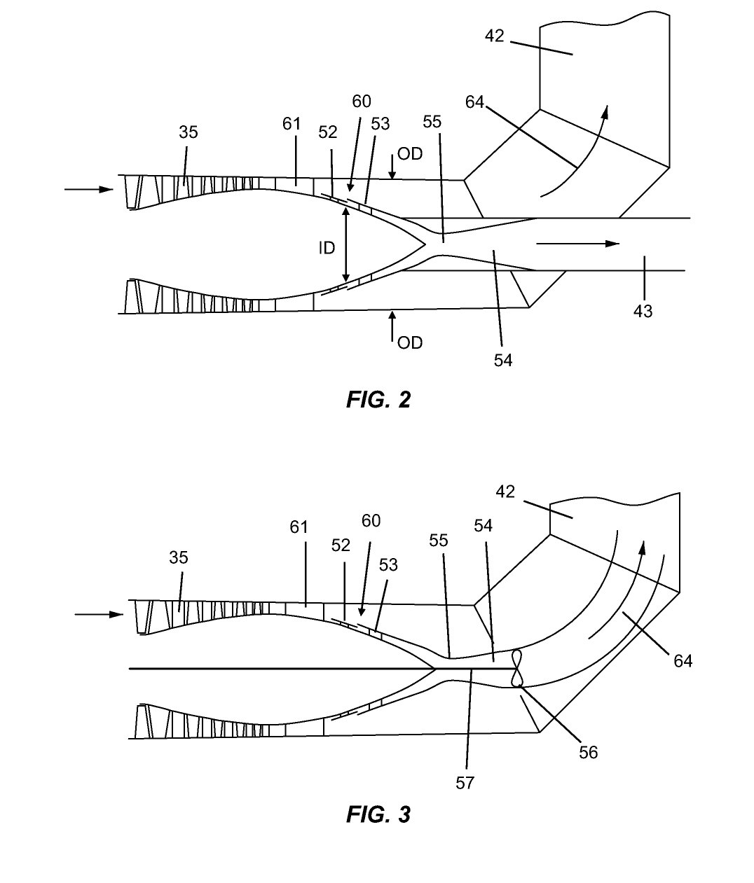

FIG. 2 shows the low pressure compressor (LPC) 35 of the IGT engine with multiple rows or stages of rotor blades and stator vanes followed by a LPC diffuser 60 and a cooling flow diffuser 54. In one embodiment, the LPC diffuser 60 is located within the outlet manifold 41. Compressed air from the compressor outlet flows along an inner surface of the diffuser 60 where a first LPC diffuser air bleed channel 52 and a second LPC diffuser air bleed channel 53 (which is downstream of the first air bleed channel 52, such that compressed air from the first air bleed channel 52 flows into the second air bleed channel 53) are located that bleeds off compressed air from the core flow 64. Each of the air bleed channels 52, 53 may be a channel having an annular cross-sectional shape. A strut 61 is located aft of the LPC 35 and near the inlet of the LPC diffuser 60. In this embodiment of the present invention, the two air bleed channels 52 and 53, located on an inner surface of the diffuser 60, each remove around 7.5% of the core flow for a total bleed off of 15% that then flows into a cooling air line 43. The core flow 64 flows through a main flow duct 42 and into the inlet of the high pressure compressor (HPC) 31 of the engine. The cooling air passing into the cooling air duct 43 flows to hot parts of the engine such as the first stage stator vanes and even the first stage rotor blades to provide cooling for these hot turbine parts.

The first 52 and second 53 air bleed channels enable a higher diffusion rate in the LPC diffuser 60 by restarting the boundary layer on the LPC diffuser 60 inner diameter (ID) flow path. The LPC diffuser 60 outer diameter (OD) flow path loading is mitigated with zero slope flow path and OD strong LPC exit velocity profile. Cooling air duct 43 diffusion in the cooling flow diffuser 54 can be delayed to minimize blockage by the cooling air duct 43 inside the LPC-to-HPC duct. The bleed off compressed air from the air bleed channels 52 and 53 flows into a throat 55 and then through a cooling flow diffuser 54 (which is also referred to herein as a diverging section 54) before entering the cooling air duct 43.

FIG. 3 shows an embodiment of the present invention in which the compressed air bled off through the air bleed channels 52 and 53 is reintroduced into the core flow duct 42 downstream where a fan 56 is used to draw off the bleed air through the air bleed channels 52 and 53 to improve the efficiency of the diffuser 60. In the FIG. 3 embodiment, the fan 56 is rotatably connected to the rotor 57 of the low spool and LPC 35. The fan 56 draws off the bleed air into a passage 55 that is then merged with the core flow 64 of the duct 42 from the LPC 35. The fan 56 improves the performance of the LPC diffuser 60. In the FIG. 3 embodiment, the air drawn off from the diffuser 60 is driven by a fan 56 connected to the rotor 57 of the low spool. The cooling air used for cooling of the turbine hot parts can be extracted from the core flow duct 42 downstream from the where fan 56 draws off the diffuser flow and upstream of where the core flow is discharged into the inlet of the high pressure compressor 31.

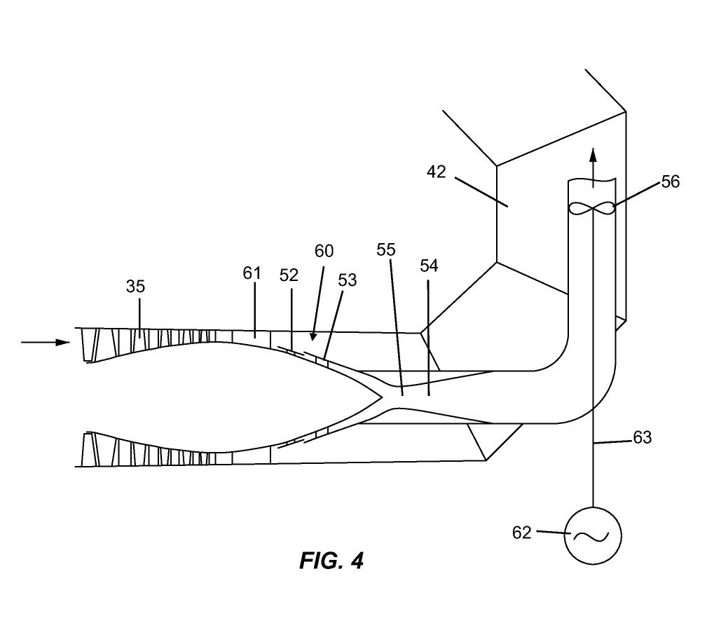

FIG. 4 shows a second embodiment of the present invention in which the compressed air bled off through the air bleed channels 52 and 53 is drawn off by a fan 56 driven by an external motor 62 through a shaft 63. The compressed air bled off through the diffuser 60 is then reintroduced into the core flow in the duct 42 downstream from the diffuser 60 to improve the performance of the diffuser 60. In the FIG. 4 embodiment, the fan 56 that draws off the flow from the diffuser 60 is driven by a motor 62 external to the low spool and the IGT engine.

In both embodiments of FIGS. 3 and 4, some of the air flow discharged from the low pressure compressor 35 is drawn off from the diffuser 60 using a fan 56 in order to improve the diffuser performance, and this drawn off air is reintroduced into the core flow duct 42 downstream of the fan 56 but upstream of where cooling air for the turbine hot parts is extracted from the core flow duct 42.

In one embodiment, an industrial gas turbine engine for electrical power production includes: a high spool with a high pressure compressor (31) and a high pressure turbine (33); a low spool with a low pressure compressor (LPC) (35) and a low pressure turbine (34); a core flow duct (42) connecting a core flow of the LPC (35) to an inlet of the high pressure compressor (31); a LPC diffuser air bleed channel (52) to bleed off a portion of the core flow; and a cooling air duct (43) connected to the LPC diffuser air bleed channel (52).

In one aspect of the embodiment, the industrial gas turbine engine further includes a LPC diffuser (60) between the LPC (35) and the core flow duct (42), the LPC diffuser air bleed channel (52) being located on an inner surface of the LPC diffuser (60), the LPC diffuser air bleed channel (52) bleeding off around 7.5% of the core flow of the LPC (35).

In one aspect of the embodiment, the LPC diffuser air bleed channel (52) is a first LPC diffuser air bleed channel, the industrial gas turbine engine further comprising: a second LPC diffuser air bleed channel (53) located downstream from the first LPC diffuser air bleed channel (52) to bleed off a second portion of the core flow, the second LPC diffuser air bleed channel being connected to the cooling air duct (43).

In one aspect of the embodiment, the first and second LPC diffuser air bleed channels (52, 53) bleed off around 15% of the core flow of the LPC diffuser (60).

In one aspect of the embodiment, the industrial gas turbine engine further includes a fan (56) located downstream of the first and second LPC diffuser air bleed channels (52, 53), the fan (56) being configured to draw off the bleed air through the first and second LPC diffuser air bleed channels (52, 53) to improve the efficiency of the diffuser (60).

In one aspect of the embodiment, the low spool includes a rotor (57), the fan (56) being rotatably connected to the rotor (57).

In one aspect of the embodiment, the gas turbine industrial engine further includes a motor (62) that is external to the low spool, the fan (56) being driven by the motor (62).

In one aspect of the embodiment, the LPC diffuser air bleed channel (52) has an annular cross-sectional shape.

In one aspect of the embodiment, each of the first and second LPC diffuser air bleed channels (52, 53) has an annular cross-sectional shape; and compressed air from the first LPC diffuser bleed channel (52) flows into the second LPC diffuser bleed channel (53).

In one aspect of the embodiment, the industrial gas turbine engine further includes a LPC diffuser (60) between the LPC (35) and the core flow duct (42), the LPC diffuser air bleed channel (52) being located on an inner surface of the LPC diffuser (60), the LPC diffuser air bleed channel (52) having an annular shaped channel on an inner surface of the LPC diffuser (60) that forms the core flow of the LPC (35).

In one aspect of the embodiment, the industrial gas turbine engine further includes a LPC diffuser (60) between the LPC (35) and the core flow duct (42), the LPC diffuser air bleed channel (52) being located on an inner surface of the LPC diffuser (60), wherein: the LPC diffuser air bleed channel (52) is an annular shaped channel; and the LPC diffuser (60) includes a throat followed by a diverging section (54) is located between the annular bleed channel (52) and the cooling air duct (43).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An industrial gas turbine engine for electrical power production comprising:
a high spool with a high pressure compressor (31) and a high pressure turbine (33);
a low spool with a low pressure compressor (LPC) (35) and a low pressure turbine (34);
a core flow duct (42) connecting a core flow of the LPC (35) to an inlet of the high pressure compressor (31);
a LPC diffuser air bleed channel (52) to bleed off a portion of the core flow; and
a cooling air duct (43) connected to the LPC diffuser air bleed channel (52).

2. The industrial gas turbine engine of claim 1, further comprising a LPC diffuser (60) between the LPC (35) and the core flow duct (42), the LPC diffuser air bleed channel (52) being located on an inner surface of the LPC diffuser (60), the LPC diffuser air bleed channel (52) bleeding off around 7.5% of the core flow of the LPC (35).

3. The industrial gas turbine engine of claim 1, wherein the LPC diffuser air bleed channel (52) is a first LPC diffuser air bleed channel, the industrial gas turbine engine further comprising:
a second LPC diffuser air bleed channel (53) located downstream from the first LPC diffuser air bleed channel (52) to bleed off a second portion of the core flow, the second LPC diffuser air bleed channel being connected to the cooling air duct (43).

4. The industrial gas turbine engine of claim 3, wherein the first and second LPC diffuser air bleed channels (52, 53) bleed off around 15% of the core flow of the LPC diffuser (60).

5. The industrial gas turbine engine of claim 1, further comprising a fan (56) located downstream of the first and second LPC diffuser air bleed channels (52, 53), the fan (56) being configured to draw off the bleed air through the first and second LPC diffuser air bleed channels (52, 53) to improve the efficiency of the diffuser (60).

6. The industrial gas turbine engine of claim 5, wherein the low spool includes a rotor (57), the fan (56) being rotatably connected to the rotor (57).

7. The industrial gas turbine engine of claim 5, further comprising a motor (62) that is external to the low spool, the fan (56) being driven by the motor (62).

8. The industrial gas turbine engine of claim 1, wherein the LPC diffuser air bleed channel (52) has an annular cross-sectional shape.

9. The industrial gas turbine engine of claim 3, wherein:
each of the first and second LPC diffuser air bleed channels (52, 53) has an annular cross-sectional shape; and
compressed air from the first LPC diffuser bleed channel (52) flows into the second LPC diffuser bleed channel (53).

10. The industrial gas turbine engine of claim 1, further comprising: a LPC diffuser (60) between the LPC (35) and the core flow duct (42), the LPC diffuser air bleed channel (52) being located on an inner surface of the LPC diffuser (60), the LPC diffuser air bleed channel (52) having an annular shaped channel on an inner surface of the LPC diffuser (60) that forms the core flow of the LPC (35).

11. The industrial gas turbine engine of claim 1, further comprising a LPC diffuser (60) between the LPC (35) and the core flow duct (42), the LPC diffuser air bleed channel (52) being located on an inner surface of the LPC diffuser (60), wherein:
the LPC diffuser air bleed channel (52) is an annular shaped channel; and
the LPC diffuser (60) includes a throat followed by a diverging section (54) is located between the annular bleed channel (52) and the cooling air duct (43).
